(19) United States
(12) Patent Application Publication
(10) Pub. No.: US 2022/0413165 A1
(43) Pub. Date: Dec. 29, 2022

(54) LAWN PROFILE DATA COLLECTING TOOL

(71) Applicant: TEXAROBA TECHNOLOGY INC., Plano, TX (US)

(72) Inventor: Jia SONG, Tulsa, OK (US)

(73) Assignee: TEXAROBA TECHNOLOGY INC., Plano, TX (US)

(21) Appl. No.: 17/801,490

(22) PCT Filed: Feb. 25, 2021
(86) PCT No.: PCT/US2021/019744

§ 371 Date: Aug. 22, 2022

Related U.S. Application Data
(60) Provisional application No. 62/981,577, filed on Feb. 26, 2020.
(60) Provisional application No. 62/981,585, filed on Feb. 26, 2020.
(60) Provisional application No. 62/991,106, filed on Mar. 18, 2020.

(51) Int. Cl. G01S 19/41; G01C 22/00

(52) U.S. Cl. CPC G01S 19/41; G01C 22/00; A01D 34/008

(57) ABSTRACT

The present invention relates to a lawn profile data collecting tool. It comprises at least two moving wheels, a chassis for mounting and connecting the wheels, a main function box sitting on the chassis, a handle provided with operative function buttons, and a rod connecting the handle and the chassis, wherein said function box includes a plurality of functional modules for detecting and collecting any information of a piece of lawn and for converting and processing such information to lawn profile data. One of the wheels is provided with a distance measuring mechanism; and the perimeter of each of the wheels has a predetermined length, which measures the distance of the wheel traveled with the count of turns of the wheel. The functional modules include a CPU for data conversion and processing; a GNSS module, a differential GNSS receiver, a Wi-Fi module, a Bluetooth module, and a camera for detecting and capturing the scene of a piece of lawn as information or knowledge of the lawn.

### CROSS-REFERENCE TO RELATED APPLICATIONS

The present application claims priority to U.S. Provisional Application No. 62/981,585 filed on Feb. 26, 2020; U.S. Provisional Application No. 62/981,577, filed on Feb. 26, 2020; and U.S. Provisional Application No. 62/991,106, filed on Mar. 18, 2020; the disclosures of which are incorporated herein by reference in the entirety as part of the present application. This application also relates to and claims priority to PCT/US21/016951, filed on Feb. 5, 2021, which claims priority to U.S. Provisional Application No. 62/971,805, filed on Feb. 7, 2020.

### FIELD OF THE INVENTION

The present invention relates to a lawn profile data collecting apparatus or tool which may automatically generate lawn profile data after going through desired places of a piece of lawn. In particular, such a lawn profile data collecting tool of the present invention is used to collect information of all aspects of any pieces of lawns, such as locations, GPS coordinates, number of zones, sizes, lengths, slopes, and conditions of the lawns, that may be transferable to and kept in a storage or memory for future use of lawn mowing or caring jobs.

### BACKGROUND OF INVENTION

Currently, border wiring or radio beacons technologies are used to facilitate the robotic lawn mowers to perform mowing of the lawns. Generally, something must be learned or known or predetermined about the lawns before a robotic mower can start mowing a piece of lawn. The available ways of learning or knowing the lawns with the above-mentioned technologies are all about how to define the boundaries of a piece of lawn. With the border wiring technology, the border wires are preset up or buried around or along every inches of the physical boundaries of the lawn for the robotic lawn mower to move around within the boundaries as so defined, and no measurement is needed for other aspects besides the boundaries of the lawn. Likewise, with the radio beacons technology, several radio beacons are planted or preset up at appropriate locations of the boundaries of the lawn, and thus the robotic lawn mower will move around the lawn with reference to the radio beacons.

The most common practice now is still to bury low voltage wires into ground and mark the boundaries of the lawn. A robotic lawn mower will mow the lawn or yard within the boundaries, most likely in a random pattern without any mowing path planning. Thus, there is no guarantee as to how much time it will take to finish mowing the entire lawn without duplicated work. Therefore, this is not efficient at all.

The radio beacon technology was proposed in 2019. It eliminates the burying of border wires around the physical boundaries of the lawn by placing beacons around the lawn so that the robotic lawn mower can learn and memory the location and radio characteristics of each and every beacon. Beacons have to stay in their exact locations at all the time, otherwise the robotic lawn mower will get lost and may go beyond boundaries if any beacon is missing or removed from the original location. This radio beacons technology may work fine with small residential yards, and the number of beacons may not be many, but the beacons would get lost or missing without notice. Thus, it may not be an easy and cost-effective way to use in commercial mowing of relatively large scale of lawns, such as football fields or golf courses, or some public areas, such as parks or roadsides. In any event, merely knowing or presetting boundaries of lawns may not assure good quality of mowing jobs because almost every pieces of lawns may not be just defined by their boundaries, but have other aspects, such as, slopes, obstacles or fixtures within the boundaries of the lawns that may affect the movement or mowing of the mowers.

Therefore, it is desirable to have a more promising, fast, and economical way to learn or know all of aspects about the lawns so as to assure good quality of mowing or other lawncare jobs for any pieces of lawns, either small or large, plain, curving, slope or uneven. And it may get rid of buried wires as well as planted beacons. Nothing needs to be planted under or above the ground and around boundaries of the lawns. This may keep a much pretty appearance of the lawn without much undesirable or non-ornamental fixtures. It can be used on any sizes of lawns and in any occasions, private properties as well as public areas.

### SUMMARY OF THE INVENTION

An object of the present invention is to learn or know all aspects of any pieces of lawns in advance by measurement to create or generate corresponding lawn profile data that reflects accurately the entire piece of any specific lawn.

The other object of the present invention is to design a specific measurement apparatus or collecting tool as local processing apparatus of lawn profile data in association with an information management system of lawn profile data, that enables the management, storage, and distribution of lawn profile data for sharing among or using by any robotic lawn mowers to perform accurate mowing jobs or broadly by lawn robots for lawncare jobs on any pieces of lawns abound the world. The lawn profile data information management system is being pursued through a related application by the applicant, which is incorporated herein by reference. Accordingly, the present invention is to design a lawn profile data collecting tool or apparatus that is used and based on the lawn profile data technology.

According to the present invention, a lawn data collecting tool or apparatus comprises a plurality of moving wheels, a chassis for mounting and connecting the wheels, a main function box sitting on the chassis, a handle provided with function buttons, and a rod connecting the handle and the chassis.

Further, according to the present invention, at least one of the wheels is provided with a distance measuring mechanism, that may be a counter. All wheels have the same perimeter and the perimeter of each wheel is set to have a predetermined length. When each of the wheels turns a circle, the distance of this tool having traveled is equal to the length of the wheel's perimeter.

Still further, the main function box contains PCB boards which include a CPU, a GPS or GNSS receiver, a differential GPS or GNSS receiver, a Wi-Fi module, a Bluetooth module, a camera, and an optional 4G/5G telecommunication module, as well as data conversion and processing module.

Moreover, the handle of the collecting tool may hold four functional buttons which are used to mark LAWN, ZONE, OBSTACLE, and SEGMENT because the lawn profile data will contain all the aspects of the lawns when the measured or rather learned or known information of the lawns as collected by the tool is converted into the lawn profile data.

Details of the present invention may be understood and will be discussed hereinafter in connection with the accompanying drawings.

### BRIEF DESCRIPTION OF THE DRAWINGS

FIG. 1a illustrates a side view of the lawn profile data collecting tool of the invention.

FIG. 1b shows a front view of the lawn profile data collecting tool of the invention.

FIG. 1c shows a top view of the lawn profile data collecting tool of the invention.

FIG. 1d shows a top view of the lawn profile data collecting tool of the invention with only the wheels and the chassis.

FIG. 2a shows a side view of a wheel with counter according to the present invention.

FIG. 2b shows atop view of the wheel with counter of the present invention.

FIG. 3 illustrates the main function box of the present invention.

FIG. 4 illustrates the basic components of the control unit of the invention.

FIGS. 5a and 5b illustrate side view of a part of the lawn with slope or with stairs.

FIG. 6a shows a perspective view of the handle with operation buttons according to the present invention.

FIG. 6b shows a front view of the handle with operation buttons of the invention.

FIG. 7 shows an example of the information and knowledge of lawns for their lawn profile data in connection with a piece of residential lawn.

FIG. 8a illustrates a side view of an alternative lawn profile data collecting tool in accordance with the present invention.

FIG. 8b shows a front view of the alternative lawn profile data collecting tool.

FIG. 8c shows a top view of the alternative lawn profile data collecting tool.

FIG. 9a shows how the lawn profile data collecting tool may be used.

FIG. 9b shows how the lawn profile data collecting tool may be used by a moving vehicle.

FIG. 10 is a flow chart illustrative of the operation or control of the lawn profile data collecting tool of the present invention for Lawn and Zone data.

FIG. 11 is a flow chart illustrative of the operation or control of the lawn profile data collecting tool of the present invention for Obstacle data.

FIG. 12 is a flow chart of the operation or control of the lawn profile data collecting tool of the present invention for Segment data.

### DETAILED DESCRIPTION OF THE INVENTION

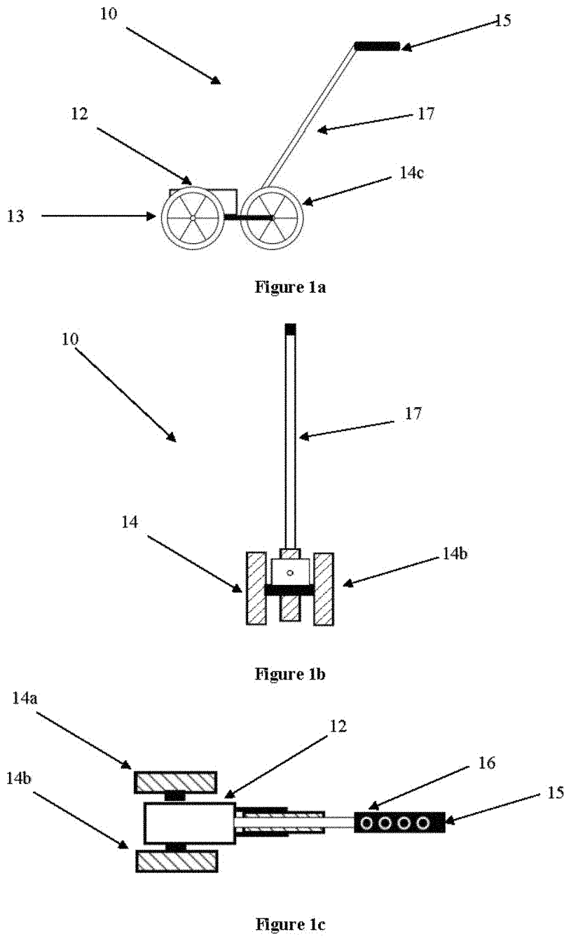

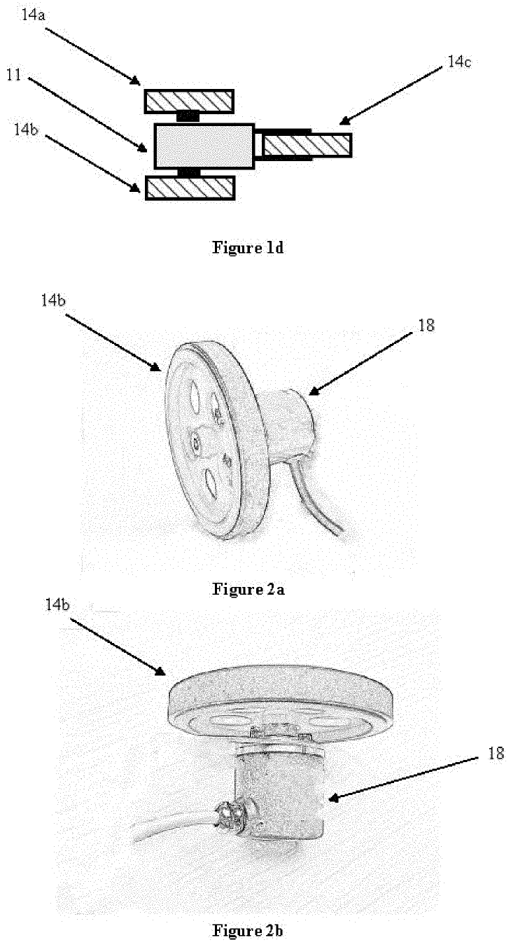

Generally, the lawn data collecting tool 10 of the present invention as shown in FIGS. 1a to 1d comprises a chassis 11 for holding a main function box 12 of the lawn data collecting tool thereon, a moving assembly 13 usually having three moving wheels 14a, 14b, 14c as an example, a handle 15 with function buttons 16 thereon, and a rod 17 connecting the handle 15 and the chassis 11. As shown in FIGS. 1a to 1d, the chassis 11 is generally a plate and two front moving wheels 14a, 14b are provided in the front section of the chassis 11 and a rear wheel 14c is on the back thereof. The function box 12 is on the front section of the chassis 11. FIG. 1c shows the top view of the data collecting tool 10 with the main function box 12 sitting on the chassis 11 which cannot be seen in FIG. 1c. FIG. 1d shows the basic components of the data collecting tool 10, with the main function box 12 removed, but the chassis 11 is shown therein.

The perimeter of each of the wheels 14a, 14b, 14c is set to a predetermined length, e.g., 16 inches or so. A length measuring sensor or counter 18 is provided and connected to the axle of one of the two front moving wheels 14a, 14b, as shown in FIGS. 2a and 2b, to count how many turns this wheel has traveled over the ground of the lawn so as to get the measurement of the length. This is just an example of one of length measuring methods.

Generally, GNSS (i.e., Global Navigation Satellite System) may include the United States' Global Positioning System (GPS), Russia's Global Navigation Satellite System (GLONASS), China's BeiDou Navigation Satellite System (BDS), the European Union's Galileo, and other non-mainstream systems. GPS is the most commonly used and preferable system; but others may be preferred in different regions or locations. Therefore, the lawn data collecting tool 10 of the present invention is designed to use GNSS for accurately positioning at any locations or any pieces of lawns.

GNSS is capable of providing geolocation and time information to a GNSS receiver anywhere on the Earth. A GNSS module is adopted in the lawn data collecting tool of the present invention as seen in FIG. 4, and it may receive signals of a single system, e.g., GPS, or it may receive signals from a plurality of systems simultaneously, that is, any combination of GPS, GLONASS, BDS, and/or Galileo. Nonetheless, merely using a GNSS may not be good enough to support positioning or navigating of inch level granularity in terms of accuracy Hence, a differential GNSS system is used so as to enable the lawn data collecting tool to achieve inch level granularity. Such a differential GNSS system may include a GNSS module and a differential GNSS receiver as seen in FIG. 4. The lawn profile data collecting tool 10 uses geolocation coordinates to mark the locations of the lawns in general.

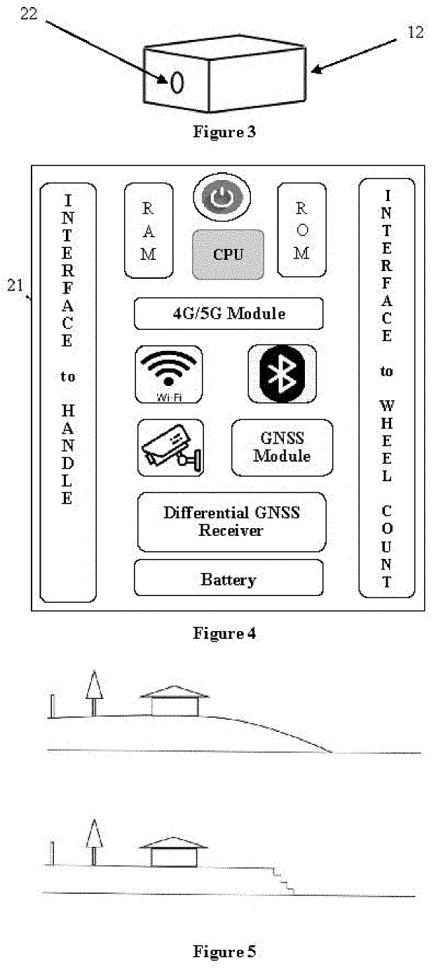

The main function box 12 is generally briefly illustrated in FIG. 3 and it contains a PCB board as shown in FIG. 4 which includes a plurality of modules as mentioned above, such as a GNSS receiver, a differential GNSS receiver, a Wi-Fi module, an optional 4G/5G telecommunication module, a Bluetooth module, a camera, and a rechargeable battery. Moreover, the lawn data collecting tool 10 is designed to include a data converter and data processor, which may be parts of or work with CPU for converting lawn profile information to lawn profile data and processing the data in specific data formats and categories.

Wi-Fi module is used as a communication means for accessing information, as well as used to identify and collect Wi-Fi signals of surrounding Wi-Fi routers or access points to build a micro positioning and navigation system of the lawn, which will be addressed in another related patent application of the same applicant. An optional 4G/5G telecommunication module may be installed in the function box 12 to provide more flexibility of communication choices. Further, 5G technology looks very promising to be used for positioning or even navigation since 5G communication would have more base stations than 4G or 3G.

Bluetooth module is used to connect to a mobile device and to transfer data between the lawn profile data collecting tool and the mobile device. In order to initiate a lawn profile data collecting job, the mobile device with an APP will first connect to the lawn profile data collecting tool to gather the information of the tool and send a request to a remote information processing center. The remote information processing center could be a physical base server facility, or a cloud based fully automated service. Once the request gets approved the information processing center, the mobile device with the APP will send instructions to the collecting tool to start data collecting job. When the data collecting job is finished, the data collected by the tool will be sent to and received by the mobile device with the APP via Bluetooth connection. After inputting the necessary information, all of the collected lawn profile data will be verified, and the verified data will be encrypted and then sent to the remote information processing center or rather the cloud storage for future use.

To start measurement and collection of information of the lawn, a differential GNSS system is used to determine coordinates and heights of points of each segment as classified according to the present invention. As described above, the moving wheel 14a or 14b equipped with counter is used to measure length or size or distance by the number of turns of the wheel as the wheel travels. Moreover, another input may be necessary to come up with a more accurate measurement of length through a length fusion algorithm. The slope of a segment can be calculated by heights of both ends. FIGS. 5a and 5b show an example of different slopes of lawns, an upward slope and a stairway.

A camera 21 is also mounted inside of the function box 12 as shown in FIG. 4, and it is usually facing forward. The lens 22 of the camera 21 is illustrated generally as a circle of the function box 12 in FIG. 3. It is well understood that the function of the camera 21 is to take photos and/or videos of whatever the data collecting tool will be facing when moving over the lawn, such as boundaries or obstacles, so that the robotic lawn mower can capture the scene for image recognition.

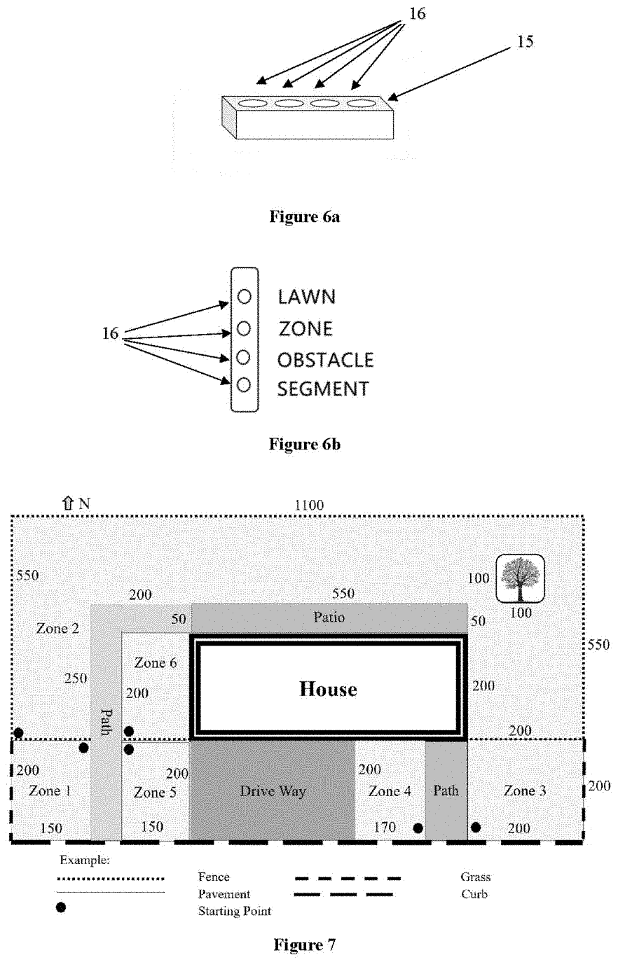

FIGS. 6a and 6b show four function buttons 16 on the handle 15, i.e., LAWN, ZONE, OBSTACLE, and SEGMENT. All of those buttons 16 are ON/OFF buttons. Push once the button will be illuminated indicative of data collection in progress. Push the same button again, the backlit button will be off indicating that the collecting job is finished. The details of the operation procedure will be discussed hereinafter.

FIG. 7 is an example of a piece of lawn. It shows a residential lot having a house which is roughly centrally located in the lot, and the lawn has been marked with several zones of different sizes and shapes. However, all other lawns can be expressed in the same way as this example, that is, how the piece of lawn be divided and classified into the information or knowledge of the lawn as its entirety, zones of the lawn or grass, any obstacles of drive way, path, pavement, trees or fence, and segments of the zones and/or obstacles, as so categorized of lawn profile data as described hereinabove.

For instance, zone 1 as shown in FIG. 7 has four segments. The starting point is on the NORTHEAST corner of the zone 1. From the starting point, each of the segments may be described clockwise, that is, Segment 1 has a length of 200 feet and goes from north to south. The object next to Segment 1 is a cement pavement of a path. Segment 2 has a length of 150 feet and goes from east to west. The object next to Segment 2 is a curb. Segment 3 has a length of 200 feet and goes from south to north. The object next to Segment 3 is grass. Segment 4 has a length of 150 feet and goes from west to east. The object next to Segment 3 is a fence.

As another example, zone 2 as shown in FIG. 7 has ten segments and one obstacle. The starting point is on the SOUTHEAST corner of zone 2. From the starting point, each segment may be described clockwise. Segment 1 has a length of 550 feet and goes from south to north. The object next to Segment 1 is a fence. Segment 2 has a length of 1100 feet and goes from west to east. The object next to Segment 2 is a fence. Segment 3 has a length of 550 feet and goes from north to south. The object next to Segment 3 is a fence. Segment 4 has a length of 200n feet and goes from east to west. The object next to Segment 5 is a fence. Segment 5 has a length of 200 feet and goes from south to north. The object next to Segment 5 is a wall. Segment 6 has a length of 50 feet and goes from south to north. The object next to Segment 6 is cement pavement of a patio. Segment 7 has a length of 550 feet and goes from east to west. The object next to Segment 7 is cement pavement of a patio. Segment 8 has a length of 200 feet and goes from east to west. The object next to Segment 8 is cement pavement of a path. Segment 9 has a length of 250 feet and goes from north to south. The object next to Segment 9 is cement pavement of a path. Segment 10 has a length of 150 feet and goes from east to west. The object next to Segment 10 is a fence.

There is an obstacle inside of zone 2. The obstacle has four segments. Segment 1 has a length of 100 feet and goes from west to east. The object next to Segment 1 is a tree. Segment 2 has a length of 100 feet and goes from north to south. The object next to Segment 2 is a tree. Segment 3 has a length of 100 feet and goes from east to west. The object next to Segment 3 is a tree. Segment 4 has a length of 100 feet and goes from south to north. The object next to Segment 4 is a tree.

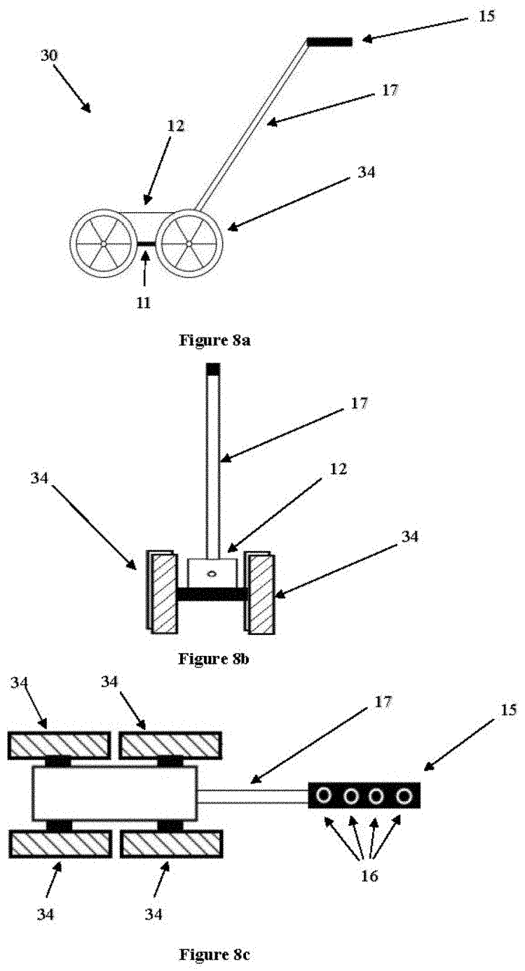

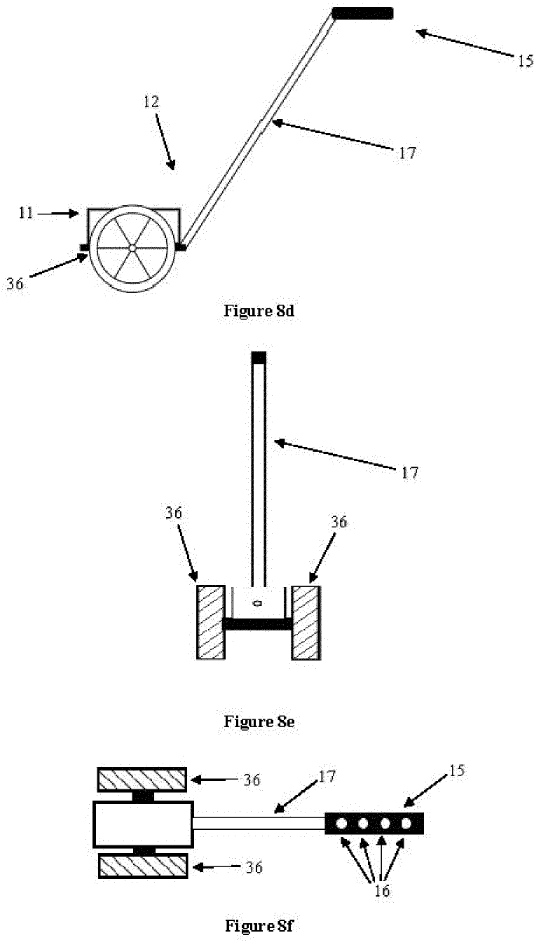

FIGS. 8a to 8c illustrates an alternative embodiment of the lawn profile data collecting tool 30, that has four moving wheels 34 instead of three wheels of the embodiment of FIG. 1a to 1d. Other features of the chassis 11, function box 12, handle 15 and connecting rod 17 are the same as the embodiment of FIGS. 1a to 1d. Nonetheless, other alternatives may also be feasible, such as the data collecting tool may have just two moving wheels. FIGS. 8d to 8f illustrate a further embodiment of two wheels 36, while the chassis 11, the main function box 12, the handle 15, the function buttons 16 and the rod 17 are the same as the other embodiments above.

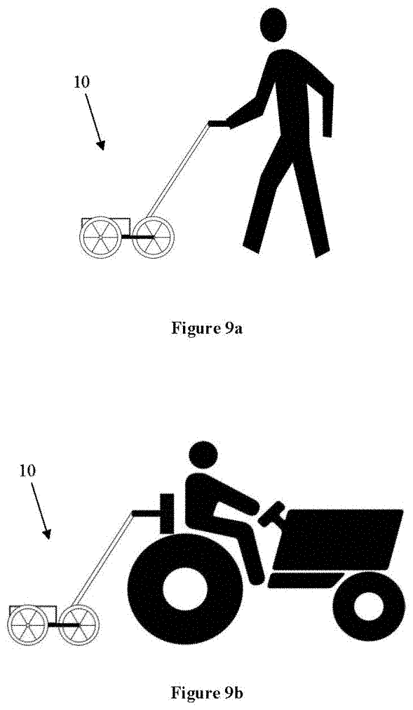

FIGS. 9a and 9b shows two possible ways of how the lawn profile data collecting tool 10 can be used. For residential or other small sized lawns, the tool can be held and pushed manually to go around the lawn and go through boundaries of lawn's zones as well as any possible obstacles inside each of zones. For large areas, such as public parks, golf courses, etc., the lawn profile data collecting tool can be attached to a moving vehicle to go around the lawn and through all boundaries.

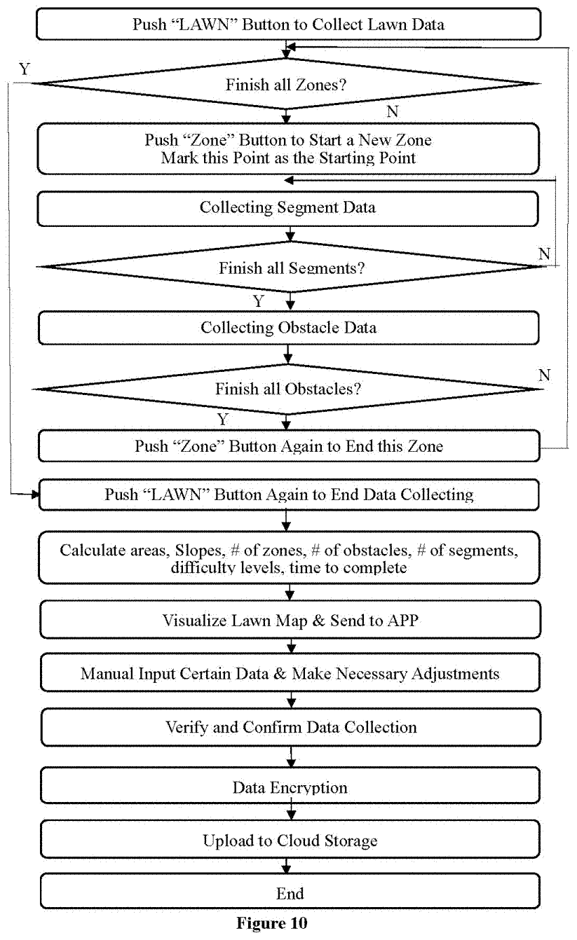

FIG. 10 illustrates the operation procedure of collecting lawn profile data with the tool. Push LAWN button first to start the procedure. The LAWN button will be illuminated to indicate that a lawn data collection is on. Next, the tool is to go through all zones of the lawn. In each of the zones, press ZONE button to start. Data of each of segments will be collected. After every segment is collected in the zone, the tool is to find out whether or not there is any obstacle in the zone. If any obstacle is found, the collection of obstacle data is to be proceeded. When the data of all segments and possible obstacles are collected, push ZONE button again to finish the data collection of this zone. When the data of all zones are collected, press LAWN button again to end the data collection of this lawn. Once the data collection is finished for the entire piece of lawn, the collected data, will be processed, such as, the calculations for the area sizes of each zone and the whole lawn, number of obstacles in each zone if there is any, number of segments in each zone, slope of each segment, time to finish mowing or caring for each zone and the lawn, difficulty level for each zone and the lawn, and so on. When all calculations are done, the processed data will be sent to a mobile device with an APP, on which such a data will be shown as a visualized map of the lawn, zones, obstacles, and segments. The surveyor or operator of the tool may key in manually some additional information about the lawn, such as address of the lawn, property of each obstacle, property of each segment, and so on, to complete the data collection. The surveyor or operator of the tool may have the right to make some adjustments based on his/her observations. When all of these data collection and processing are done, the surveyor or operator will verify and sign for this data collection. Such data will then be encrypted in the APP and uploaded to the cloud storage or the remote information processing center.

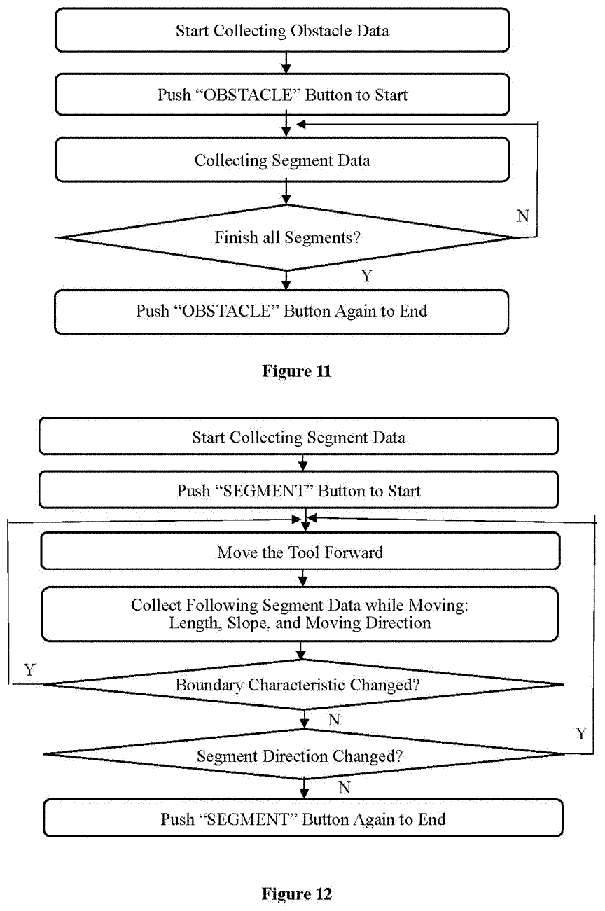

FIG. 11 shows the flow chart of collecting obstacle data with the lawn profile data collecting tool. Position the tool to a proper place of the obstacle to mark it as the starting point. Push OBSTACLE button to start. Segment data for this obstacle will be collected first. After all segment data of the obstacle is collected, press OBSTACLE button again to end the data collection of the obstacle.

FIG. 12 illustrates the flow chart of how segment data is collected. Likewise, press SEGMENT button on the handle. And push the tool to go through all boundaries in a clockwise or counterclockwise direction. While going through a boundary, the tool collects length, direction, and slope information. When the property of a boundary changes, it is the end of the current segment. If property does not change, but the direction of a boundary changes in a predetermined degree, it is another condition of the end of the current segment. Push SEGMENT button again to end this segment.

Generally for those lawn profile data, a LAWN contains one or more ZONES. A ZONE contains SEGMENTS and possible OBSTACLES. An OBSTACLE contains SEGMENTS. In the flow chart of LAWN data, the collection of OBSTACLE and SEGMENT data are just illustrative, not given in details. They are given in details in the OBSTACLE flow chart. Things become obstacles only when they are in a ZONE. As an example, one obstacle, i.e., the tree, is shown in zone 2 in FIG. 7.

The essence of the present invention has been described above. The lawn profile data collecting tool disclosed here is a separate apparatus. However, it is understood that such apparatus may be integrated as part of any robotic lawn mowers so long as the mowers may be equipped with the aforesaid functions; and thus, the mowers may serve as the data collecting tool. This should be within the scope of the present invention as described above and defined in the accompanying claims.

1. A lawn profile data collecting apparatus, comprising at least two moving wheels, a chassis for mounting and connecting the wheels, a main function box sitting on the chassis, a handle provided with operative function buttons, and a rod connecting the handle and the chassis, wherein said function box includes a plurality of functional modules for detecting and collecting any information of a piece of lawn and for converting and processing such information to lawn profile data.

2. The data collecting apparatus of claim 1, wherein one of the wheels is provided with a distance measuring mechanism; and the perimeter of each of the wheels has a predetermined length, which measures the distance of the wheel has traveled with the count of turns of the wheel.

3. The data collecting apparatus of claim 1, wherein said functional modules includes at least a CPU for data conversion and processing; a GNSS module, a differential GNSS receiver, a Wi-Fi module, a Bluetooth module; and a camera for detecting and capturing the scene of a piece of lawn as information or knowledge of the lawn.

4. The data collecting apparatus of claim 1, wherein said functional modules include an optional 4G or 5G communication module, and a data conversion and processing module to work with the CPU to create the lawn profile data on the basis of the collection of the information and knowledge of the lawn.

5. The data collecting apparatus of claim 3, wherein the differential GNSS system for determining the coordinates of the lawn.

6. The data collecting apparatus of claim 1, wherein the lawn profile data obtained by the data collecting apparatus include at least data of LAWN, ZONE, OBSTACLE, and SEGMENT in data format as converted and processed.

7. The data collecting apparatus of claim 6, wherein the handle is provided with four functional buttons, indicative of respective lawn profile data of LAWN, ZONE, OBSTACLE, and SEGMENT.

8. The data collecting apparatus of claim 1, wherein said at least two moving wheels are positioned under the chassis.

9. The data collecting apparatus of claim 1, wherein said at least two moving wheels are three wheels, two of which are positioned in the front of the chassis, and one of which is on the back.

10. The data collecting apparatus of claim 1, wherein said at least two moving wheels are four wheels, two of which are positioned in the front of the chassis, and two of which are on the back.

11. The data collecting apparatus of claim 1, wherein said handle of the data collecting apparatus can be connected to a moving vehicle.

12. A lawn profile data collecting apparatus, comprising at least two moving wheels, a chassis for mounting and connecting the wheels, a main function box sitting on the chassis, wherein said function box includes a plurality of functional modules for detecting and collecting any information of a piece of lawn and for converting and processing such information to lawn profile data.

13. The data collecting apparatus of claim 12, wherein one of the wheels is provided with a distance measuring mechanism; and the perimeter of each of the wheels has a predetermined length, which measures the distance of the wheel has traveled with the count of turns of the wheel.

14. The data collecting apparatus of claim 12, further comprising a handle provided with operative function buttons, said operative function buttons being operable with the functional modules respectively.

15. The data collecting apparatus of claim 12, further comprising a rod connecting the handle and the chassis.

16. The data collecting apparatus of claim 12, wherein said functional modules includes at least a CPU for data conversion and processing; a GNSS module, a differential GNSS receiver, a Wi-Fi module, a Bluetooth module; and a camera for detecting and capturing the scene of a piece of lawn as information or knowledge of the lawn.

17. The data collecting apparatus of claim 12, wherein the lawn profile data include at least data of LAWN, ZONE, OBSTACLE, and SEGMENT, representative of lawn properties of any pieces of lawns for lawn mowing and caring.

18. The data collecting apparatus of claim 12, wherein the plurality of functional modules main function box includes communication module which is capable of communicating with a mobile device and a remote information processing center, as well as a cloud storage for storage of such lawn profile data.
